(19) United States
(12) Patent Application Publication
(10) Pub. No.: US 2003/0047506 A1
(43) Pub. Date: Mar. 13, 2003

(54) Filter for injection molding machine

(75) Inventors: Kazuyoshi Suehara, Kanagawa (JP); Yoshihiro Tominaga, Kanagawa (JP); Nobuyuki Iwazaki, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/235,706

(22) Filed: Sep. 6, 2002

(30) Foreign Application Priority Data
Sep. 12, 2001 (JP) 2001-277030

(51) Int. Cl. B01D 29/35

(52) U.S. Cl. 210/497.01; 210/498

(57) ABSTRACT

An injection molding machine includes a nozzle for supplying a melted resin into a mold. In the nozzle, there is a filter for removing foreign materials mixed in the melted resin. The filter has a cylindrically-shaped filter body. In the filter body, many small holes are formed. By supplying the melted resin into the mold, the melted resin passes through the small holes into outside of the filter body. In cleaning the filter, the melted resin flows from the outside into the inside. The small holes each are smaller on the inside than the outside.

### BACKGROUND OF THE INVENTION

1. Field of the Invention

The present invention relates to a filter for an injection molding machine for removing foreign material from a melted resin for injection molding.

2. Description Related to the Prior Art

When a plastic molded article is produced, a pellet of plastic is used. The pellet, even if it is prepared by pelletizing a virgin plastic, often contains foreign material, such as grains of sand, metals, dusts and the like. The foreign materials are usually mixed with the pellet in producing processes of the pellet, a silo for preserving the pellet in a factory of injection molding, a process of conveying the pellet in the factory, apparatuses and processes from the silo to an injection molding machine.

Considering circumstance problems, the plastic which is most likely used as a raw material is often recycled. In recycling the plastic, the used plastic is processed into a recycled pellet or recycled tips. Recently, for the purpose of the energy conservation and the decrease of cost, the amount of a recycled plastic, such as recycled pellets or recycled tips, are acceleratively increased. However, the plastic often obtains foreign material and stains while it is provided in the market as a plastic molded article. Accordingly, when the plastic is reused, cleaning or other processing for removing the foreign materials from a recycled plastic are carried out in a recycling factory.

The foreign materials, if not solid, can be almost perfectly removed. When the solid foreign materials are contained in the recycled plastic, some of the plastic molded articles molded with the injection molding machine becomes inferior. Further, it causes a stuff with the foreign materials in a mold of an injection molding machine and a break of the mold. In this case, a production of the plastic molded articles is stopped, and an efficiency of the production is decreased

In injection molding machine disclosed in Japanese Patent Laid-Open Publications No. 3-140225 and 10-217281, a filter is included in an injection nozzle in order to remove the foreign materials mixed in a pellet of the plastic before injection molding, especially in a recycled pellet made of a recycled plastic.

However, in the injection molding machine illustrated in the publication No. 3-140225, the filter has slits, through which the melted resin passes. In the melted resin there are thin metallic fragments, thin film fragment tender metal wire, tender string-shaped substances and the like as the foreign materials. These foreign materials cannot be removed from the melted resin by the slits of the filter. Further, the foreign materials removed from the melted resin causes to decrease a filtration effect of the filter. In cleaning the filter, the melted resin may be fed in a reverse direction. However, as some of the foreign material caught in the slits, they can be removed only by applying the melted resin under high pressure.

The Publication No. 10-217281 discloses a filter in which plural holes are formed in a certain pitch. The filter causes a pressure loss in injection molding. In order to decrease the pressure loss, this publication discloses another filter having slits through which the melted resin passes in injection molding. However, it is hard to perfectly remove the foreign material having long shape from the melted resin.

### SUMMARY OF THE INVENTION

An object of the present invention is to provide a filter for injection molding machine, with which foreign materials having long-shaped form can be removed effectively from a melted resin without a pressure loss.

Another object of the present invention is to provide a filter for injection molding machine, whose cleaning is carried out easily.

In order to achieve the object and the other object, a filter of the present invention includes a cylindrical filter body having first and second surfaces and plural small holes formed in the filter body. The filter is disposed in an injection molding machine. When a melting resin is supplied in a mold, the melted resin flows from a first surface to a second surface of the filter body, and thereby the holes removes foreign materials contained in the melted resin. In cleaning the filter for removing the foreign materials caught by the holes, the melted resin flows from the second surface to the first one.

The holes each are circular ones, and has a convergent shape having a smaller size on the first surface than the second surface. A total size of the holes on the second surface is larger than the minimum size of a cross-section of passages of the melted resin.

According to the invention, as the total size of the holes are larger than the minimum size of a cross-section of the passages in the injection molding machine, the pressure loss caused by the filter becomes smaller. Further, as the holes has a convergent shape, the foreign materials are easily removed from the filter without applying high injection pressure in cleaning. Further, as the holes are circular, the long foreign materials in the melted resin are surely captured.

### BRIEF DISCRIPTION OF THE DRAWINGS

The above objects and advantages of the present invention will become easily understood by one of ordinary skill in the art when the following detailed description would be read in connection with the accompanying drawings.

FIG. 1 is a diagrammatic view of a diagrammatic view of an injection molding machine including a filter of the present invention;

FIG. 2 is a cross-sectional view of a nozzle in injection molding;

FIG. 3 is a perspective view of the filter for injection molding of the present invention;

FIG. 4 is a partial cross-sectional view of the filter in FIG. 3; and

FIG. 5 is a cross-sectional view of the nozzle in cleaning.

### PREFERRED EMBODIMENTS OF THE INVENTION

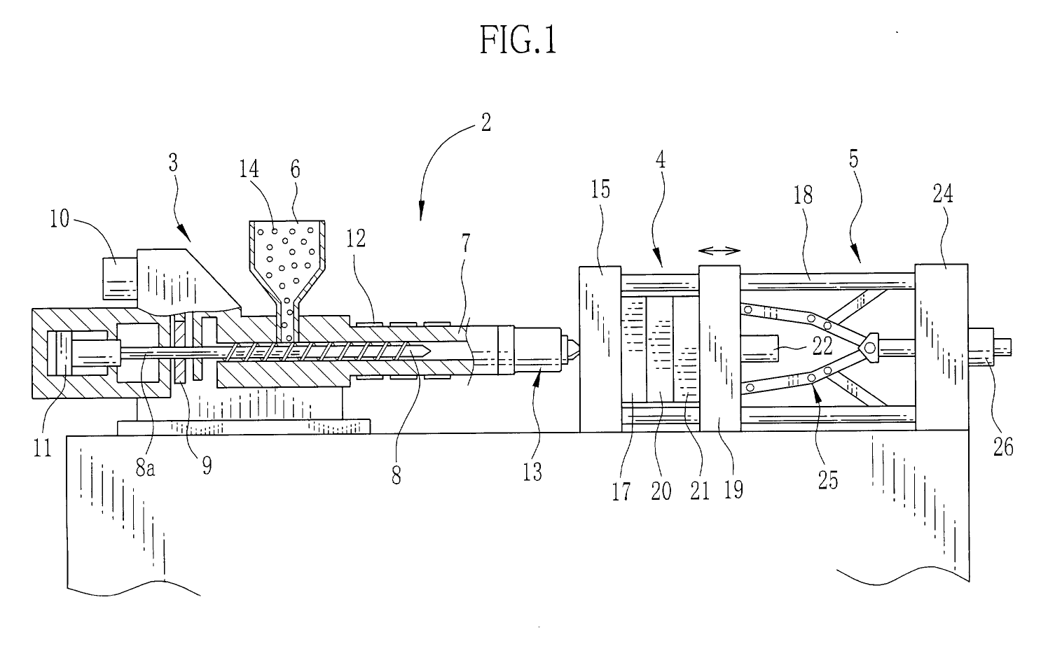

In FIG. 1, an injection molding machine 2 is used for injection molding of plastic, and constructed of an injection unit 3, a mold unit 4 and a mold clamping unit 5. The injection unit 3 includes a hopper 6, a heat cylinder 7, a feed screw 8, a speed reduction gear 9, an oil pressure motor 10, an injection cylinder 11, band heater 12 and a nozzle 13. The nozzle 13 is attached to an end of the heat cylinder 7.

In order to carry out injection molding with the injection molding machine 2, a recycled crushed resin 14 is used. As already known, the used plastic articles are withdrawn into a recycling plant. In the recycling plant, a cycle of recycling processes, such as crashing, remove of foreign material, fine crashing, cleaning, drying, remove of metal and the like, is carried out to obtain the crushed resin 14.

The crushed resin 14 is supplied in the hopper 6, and fed from the hopper 6 in the heat cylinder 7. In the heat cylinder 7, a feed screw 8 is inserted. A back end of a shaft 8a of the feed screw 8 is attached to the injection cylinder 11, and on a shaft 8a of the feed screw 8 the speed reduction gear 9 is attached. The speed reduction gear 9 is meshed with the oil pressure motor 10. The oil pressure motor 10 drives the reduction gear 9 to rotate the feed screw 8, and the injection cylinder 11 shifts the feed screw 8 back- and forwardly in the heat cylinder 7.

The band heater 12 is provided around the heat cylinder 7. The band heater 12 generates the heat to melt the crushed resin 14 fed in the heat cylinder 7. Further, the friction of the crushed resin 14 causes to generate the heat, when the feed screw 8 is rotated. Accordingly, the crushed resin 14 is melted into a melted resin 14a in the heat cylinder 7. The melted resin 14a is fed in the nozzle 13 by slide of the feed screw 8 in forward.

The mold unit 4 is constructed of the stationary platen 15, a stationary mold 17, guide rods 18, movable platen 19, a movable mold 20 and a mold support plate 21. The stationary mold 17 is attached to the stationary platen 15, and ends of the guide rods 18 are fixedly fitted in holes (not shown) formed in the stationary platen 15. A surface of the movable platen 19 is provided with a mold support plate 21 which holds to the movable mold 20. Another surface of the movable platen 19 is provided with an ejector cylinder 22 for driving an ejector pin (not shown) to eject the plastic molded article from the movable mold 20.

The mold clamping unit 5 is constructed of a base plate 24, a toggle mechanism 25 and a mold clamping cylinder 26. The base plate 24 has holes (not shown) in which other ends of the guide rods 18 are fixedly fitted. When the mold clamping cylinder 26 is driven, the movable platen 19 is slid through the toggle mechanism 25 along the guide rod 18.

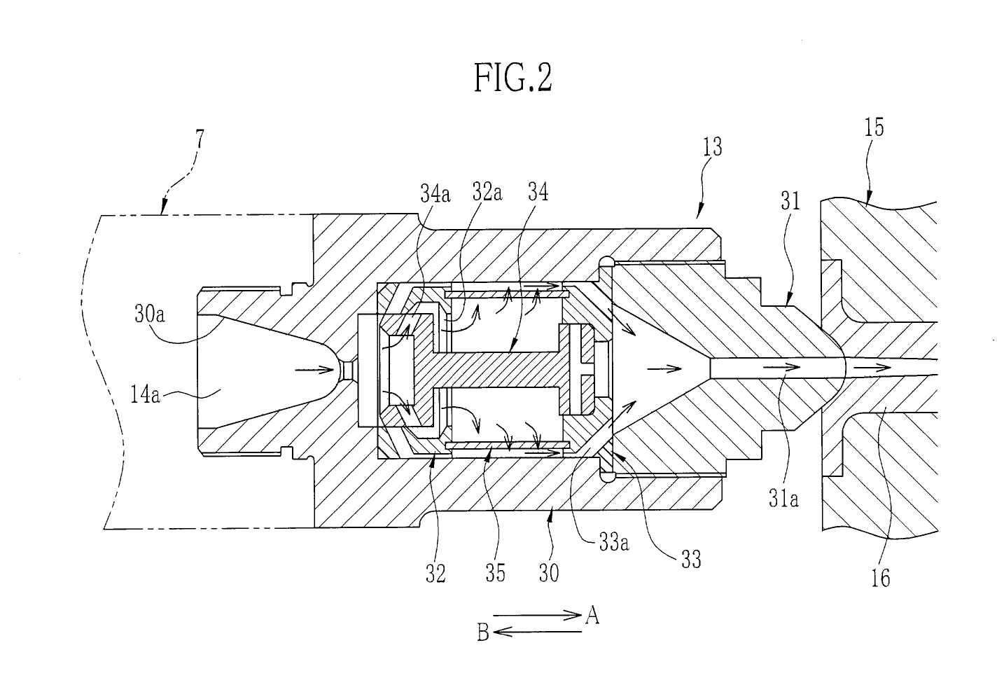

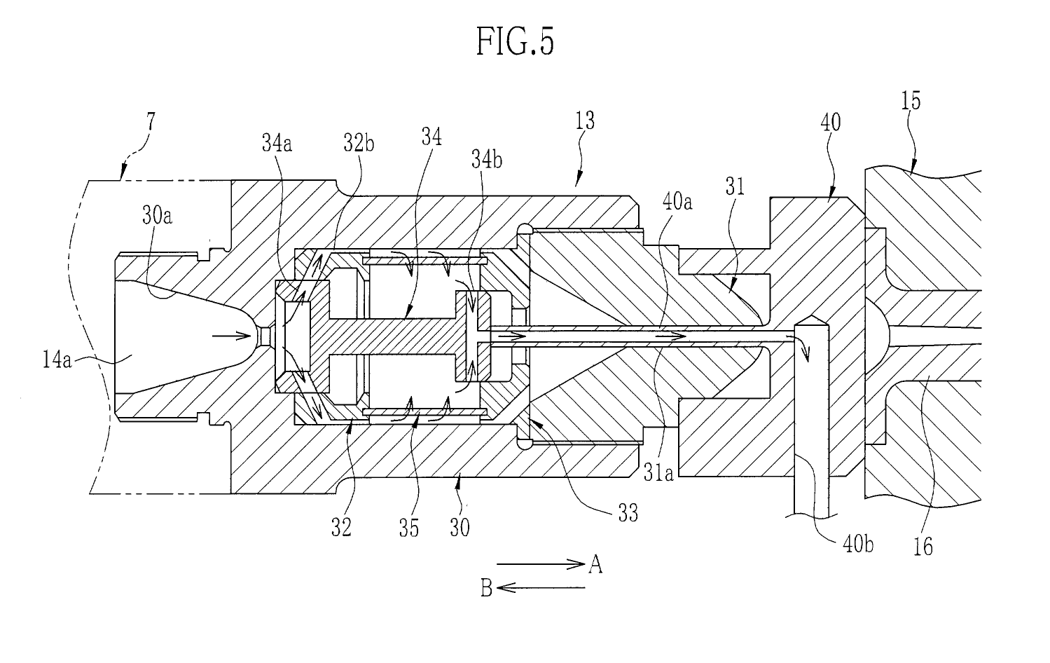

In FIG. 2, the nozzle 13 includes a nozzle case 30, a nozzle head 31, a first cap 32, a second cap 33, a passage changer 34 and a filter 35. The nozzle case 30 is nearly cylindrically shaped and attached to an end of the heat cylinder 7. The nozzle head 31 is attached to an end of the nozzle case 30, and contacted to a spur bush 16 of the mold unit 4 when the melted resin 14a is fed into the mold unit 4. The passage changer 34 shifts in directions A and B between an injection position and a cleaning position (see FIG. 5) to change passages of the melted resin 14a. Further, in the nozzle case 30, the first cap 32 and the second cap 33 are formed a resin entrance 30a, inner passages 32a and outer passages 33b, respectively. Between the first cap 32 and the passage changer 34, there is a first connect passages 34a and a second connect passages 34b. Further, in the nozzle head 31 an injection passage 31a is formed.

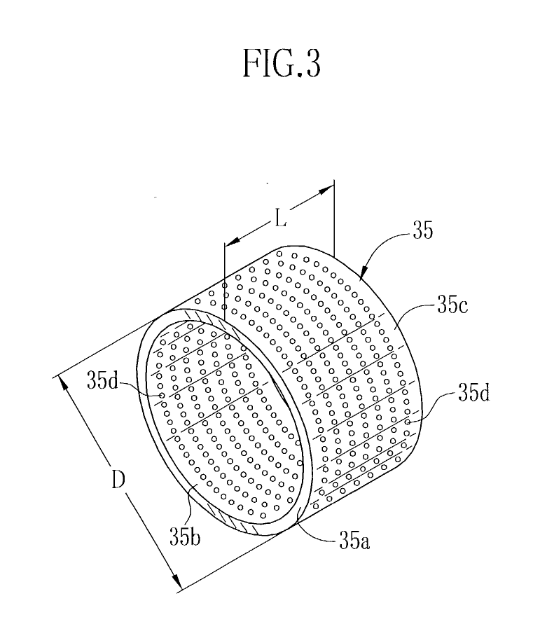

In FIG. 3, the filter 35 includes a filter body 35a formed of a metal plate in a cylindrical shape. The filter body 35a has an inner face 35b and an outer face 35c. For example, a diameter D of the filter 35 is 45 mm, and the length L is 30 mm. In the filter body 35a, many small holes 35d are formed. Note that the filter body 35a is made of hyper strong steel in order to obtain pressure-tightness for preventing the break of the injection molding machine 2 in maximum of the pressure applied by a cylinder.

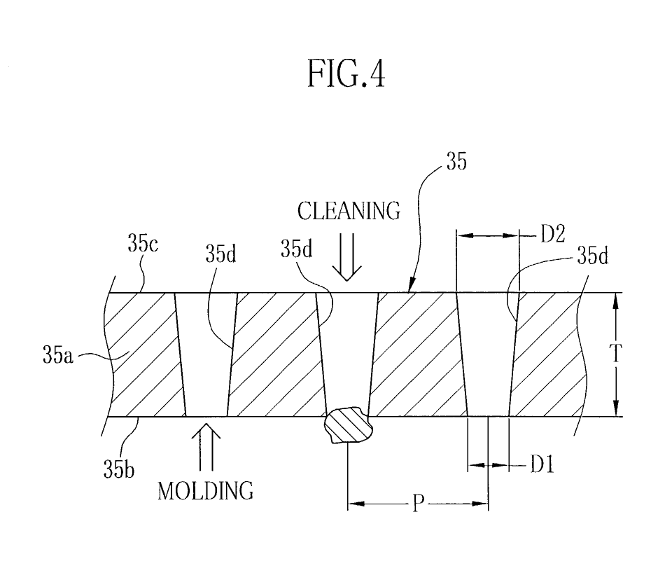

In FIG. 4, a thickness “T” of the filter body 35 is 2 mm. The small hole 35d has a taper shape, and a diameter D1 on the outer face 35c is 20% smaller than a diameter D2 on the inner face 35b. The diameter D2 of the small hole 35d is 0.2 mm, and a ratio of T/D2 is 10. The small holes 35d having this size can surely remove the foreign materials. Further, a hole pitch P is 0.5 mm, which is almost the limitation pitch of forming the small holes 35d. When the small holes having the diameter D2 in 0.2 mm is formed at a pitch of 0.5 mm in the filter body 35a having the diameter D of 45 mm and the length L of the 30 mm, the number of the small holes 35d is 15414, and the total size thereof is corresponds to a hole having a diameter of 24.8 mm. The total size is larger than a minimum size of cross-section of passages of the melted resin 14a in a generally used injection molding machine or mold. Namely, the total size is larger than the cross section of the passage such as the injection passage 31a. Accordingly, considering the resistance in the passages of the filter 35, the pressure loss becomes lower enough.

The small hole 35d is hardly formed in the filter 35 with a machine processing, radiation processing and the like, considering the pitch, the number of holes, the thickness of the filter, the accuracy of forming the holes, time for processing, and the cost. Further, it may be considered to carry out the laser processing for opening the holes. However, as the energy in the laser processing is not so high, much time is necessary therefore. Accordingly, the temperature of a filter becomes higher, which causes to deform the nearest holes.

In the embodiment of the present invention, the small holes 35d are effectively formed in a plate by the electric beam processing in which the energy is high and electric beams may be narrow. Further, in order to form taper-like shaped holes, conditions of processing should be adjusted. After processing the plate is curved to form a cylindrical shape, and both sides thereof are connected.

Operation of the present invention are explained now. In injection molding, the crushed resin 14 is heated to become to the melted resin 14a, and the melted resin 14a flows into the resin entrance 30a of an end of the nozzle case 30. The melted resin 14a in the resin entrance 30a presses the passage changer 34 to slide in the arrowed direction A. Thereby, the first connect passage 34a formed at a back end of the passage changer 34 becomes connected with the inner passage 32a of the first cap 32. The melted resin 14a flowing out from the first cap 32 passes through the small holes 35d to an outside of the filter 35. Thereby, as the foreign materials cannot pass through the small holes 35d, the foreign materials are removed from the melted resin 14a used for injection molding.

After passing through the small holes 35d, the melted resin 14a flows through the outer passage 33a of the second cap 33 into the nozzle head 31. The melted resin 14a in the nozzle head 31 passes through the spur bush 16 and is pressed to enter in the stationary mold 17. As already known, the melted resin 14a fills in a cavity formed by the stationary mold 17 and the movable mold 20 and molded to the plastic molded article.

When the foreign materials are trapped in the filter 35, the pressure loss becomes larger. In order to remove the foreign materials from the filter 35, the cleaning may be carried out. In order to carry out the cleaning of the filter 35, as shown in FIG. 5, a cleaning nozzle 40a of a cleaning plunger 40 is inserted in the injection passage 31a of the nozzle head 31, and the cleaning plunger 40 is pressed onto the stationary platen 15. The cleaning nozzle 40a presses the passage changer 34 to slide toward the heat cylinder 7.

When the passage changer 34 is slid in the arrowed direction B, the first connect passage 34 is connected with the outer passage 32b of the first cap 32. Then, after feeding the melted resin 14a from the heat cylinder 7, the melted resin 14a passes through the outer passage 32b of the first cap 32 to flow into the outside of the filter 35. Then the melted resin 14a passes through the small holes 35d of the filter 35 to flow in the inside of the filter 35. Thereby the foreign material is removed by the flow of the melted resin 14a in the holes 35. Thereafter, the melted resin 14a passes through the second connect passage 34b of the end of the passage changer 34, is fed in the cleaning nozzle 40a of the plunger 40, and fed out from an outlet 40b.

As the cleaning is carried out without disassembling the nozzle 13, the time for removing the foreign materials saves. Further, in order to carry out the cleaning, the cleaning plunger 40 is fitted in the nozzle head 31. Accordingly, the cleaning is made in a simple processing. Furthermore, as each of the small holes 35d is taper-like shaped, the foreign material caught with the small holes 35d, and it is not necessary to apply the high pressure to the crushed resin 14 in injection molding.

In the embodiment above, the filter 35 is used in the injection molding machine for molding from crashed resin. However, the filter 35 is also used in the injection molding machine in which the recycled pellet and the virgin resin are used. In this case, as the filter has an effect to mix the virgin plastic and the recycled plastic, a device for mixing the virgin plastic and the recycled plastic may be omitted. Note that the foreign materials are more effectively removed when the small holes 35d are formed so as to have smaller diameter. However, it is difficult to form the small holes 35d with smaller diameter. Further the cost of producing the filter 35 becomes higher and the pressure loss in injection molding is larger.

Various changes and modifications are possible in the present invention and may be understood to be within the present invention.

What is claimed is:

1. A filter for injection molding machine, said injection molding machine having a nozzle for injecting a melted resin in a mold, said filter comprising;
a filter body disposed in said nozzle, said filter body being cylindrically shaped to have first and second surfaces; and
plural holes formed in said filter body, said holes removing foreign materials contained in said melted resin when said melted resin flows from said first surface to said second surface, and a total size of said holes being larger than a minimum size of passage of said melted resin.

2. A filter according to claim 1, wherein said holes are circular holes.

3. A filter according to claim 2, wherein said melted resin flows from said second surface to said first surface in filter cleaning for removing said foreign materials caught by said holes.

4. A filter according to claim 3, wherein each of said holes is a convergent hole whose diameter is larger on said first surface than on said second surface.

5. A filter according to claim 4, wherein said first surface is an inner surface of said filter body and said second surface is an outer surface of said filter body.

6. A filter for injection molding machine, said injection molding machine having a nozzle for injecting a melted resin in a mold, said filter comprising;
a filter body disposed in said nozzle, said filter body being cylindrically shaped to have first and second surfaces;
plural holes formed in said filter body, said holes removing foreign materials contained in said melted resin when said melted resin flows from said first surface to said second surface; and
wherein said holes are convergent holes whose diameter is smaller on said first surface than said second surface.

7. A filter according to claim 6, wherein said melted resin flows from said second surface to said first surface in filter cleaning for removing said foreign materials caught by said holes.
